(19) United States
(12) Patent Application Publication
(10) Pub. No.: US 2007/0193759 A1
(43) Pub. Date: Aug. 23, 2007

(54) Dust suppression boot for a power tool

(76) Inventors: Brian M. Sweig, Carmel, NY (US); Paul Silva, Danbury, CT (US)

Correspondence Address: DARBY & DARBY P.C., P.O. BOX 770, Church Street Station, New York, NY, 10008-0770, US

(21) Appl. No.: 11/367,009

(22) Filed: Mar. 1, 2006

Related U.S. Application Data
(63) Continuation-in-part of application No. 11/359,869, filed on Feb. 21, 2006.

(51) Int. Cl. B25D 17/04

(52) U.S. Cl. 173/198; 173/171

(57) ABSTRACT

In one exemplary embodiment, a power tool assembly includes a percussive power tool having a cutting tool with a cutting edge; a vacuum source; and a dust suppression boot for attachment to the power tool and vacuum source in such a way that unwanted foreign matter, such as dust, particles, etc., that is generated when a work surface (e.g., concrete surface) is broken apart is collected and evacuated from the work space through the boot. This results in a much cleaner and safer work environment, as well as substantially reducing the preparation time and cleanup times, as well as reducing overall costs.

### CROSS-REFERENCE TO RELATED APPLICATIONS

This present application is a continuation-in-part of U.S. patent application Ser. No. ______, filed Feb. 21, 2006, entitled DUST SUPPRESSION BOOT FOR A POWER TOOL and identified by Attorney Docket No. 20672/0203995-U.S. , which is hereby incorporated by reference in its entirety.

### TECHNICAL FIELD

The present invention relates generally to a dust suppression device, and more particularly, to a guard or boot that can be used with an existing power tool and is configured for preventing dust and other foreign material from becoming airborne during concrete cutting operations, especially the cutting of concrete inside a building when work is performed, such as the cutting of drywall, installation of interior drainage tile, miscellaneous plumbing work, or any other circumstance where concrete needs to be cut within an enclosed environment.

### BACKGROUND

One problem that is germane to the construction industry is the issue of how to deal with dust, chips and other foreign matter and particles that are liberated into the air during repair work or installation jobs inside of a house, such as interior work of basements, concrete crawl spaces and concrete slabs or the like. This problem continues to plague the construction business since the concrete must typically be cut or jack-hammered so that repairs can be made below the level of the concrete. When the concrete is cut either by a power tool, such as a concrete saw or jack-hammer, a considerable amount of dust, chips, particles and other foreign matter is generated and spreads over a wide area. It is very difficult to contain the dust, particles and foreign matter since this material gets airborne and then easily spreads over a wider area than just the work area, e.g., once airborne, the dust can spread around the entire room and can even get into an air ventilation system and therefore, could be transported to other areas and rooms, as well.

Consequently, the resulting dust not only creates substantial cleanup issues for the construction crew and the owner of the building but also creates health issues and concerns since the airborne dust and particles can be breathed in by the operator of the power tool. The repeated inhalation of this type of material can lead to respiratory problems and other health issues, etc.

A number of different attempts have been made to minimize the problems that are associated with the generation of dust in the interior work space. For example, one method was to spray the concrete with water in an attempt to prevent dust from becoming airborne on the principle that the dust will contact and bond to the water as opposed to becoming airborne. When this method was used, a water spray unit was attached to the power tool, e.g., jack hammer and was connected to a water supply, such as a water hose, to provide a continual supply of misted water to a location near where the jack hammer is being used and where the concrete is being cut. Unfortunately, this method was only partially effective since dust still escapes and the application of water to the site creates a messy environment. Also, the spraying of a mist results in the mist being transferred onto other objects that are in the vicinity of the work space and the combination of dust and particles with water results in a slurry being formed. The slurry must then be removed by the operator of the tool and this clean-up job takes some time and therefore, adds to the time that the overall job requires.

Another method that has been used is to lay wet cardboard or other fibrous material on the area that is to be cut and then the power tool (jack hammer) cuts through this material again in an attempt to reduce the amount of dust that can become airborne. Unfortunately and once again, this method is only partially effective since dust can freely travel and escape through holes that are formed through the cardboard. Yet another method to reduce the amount of airborne dust is to place fans or the like in the work area or in locations of door or windows to route the airborne dust out of the structure. Once again, while some of the dust is evacuated, a fair amount of the dust and particles are not routed along the desired flow path but instead are delivered to other locations within the structure as opposed to being delivered outside the structure. Also, even if dust is evacuated outside, the dust can settle on objects outside, such as other structures, vehicles, etc., and the dust can even be received into an air intake vent and thus be spread into an interior of the other structure.

Another method was to place protective coverings, such as drop cloths, in the work space and on top of furniture, floors, rugs, and other contents of the room. This method does not attempt to prevent the dust and particle from becoming airborne but instead, the coverings merely attempt to control and contain the dust and particles. This is a labor intensive effort since the coverings must be laid out in the target areas and desired locations within the work space and then after the cutting job is complete, the coverings must be carefully picked up such that the collected dust and particles are contained by the coverings. In addition, the covering may break or otherwise become damaged, thereby allowing the dust and particles to spread over the entire work space.

While attempts have been made to make a dust suppression guard or the like, these products suffer from a number of deficiencies. In general, these devices are constructed as part of the power tool (ack hammer) which prevents the operator from using the device without the guard feature as would be the case in an outside job. In the case where the device is removable from the power tool, the device for the most part is overlie complex and can be difficult to attach to the power tool and further, there can be difficulty in retrofitting the device on particular power tools. Other associated disadvantages are that the devices can be expensive to manufacture and the integrity and robustness of the devices can be questionable.

What is needed in the art and has heretofore not been available is a dust suppression guard or boot that overcomes the deficiencies associated with the prior art and is configured to be retrofitted on conventional power tools.

### SUMMARY

In one exemplary embodiment, a power tool assembly includes a percussive power tool having a cutting tool with a cutting edge; a vacuum source; and a dust suppression boot for attachment to the power tool in such a way that unwanted foreign matter, such as dust, particles, etc., that is generated when a work surface (e.g., concrete surface) is broken apart is evacuated from the work space. This results in a much cleaner and safer work environment, as well as substantially reducing the preparation time and cleanup times, as well as reducing costs.

The boot is a semi-flexible member that include a hollow main body having a first end for attachment to a body of the power tool and an opposing second end, wherein in a rest position, the cutting edge extends beyond the second end. The boot further includes a hollow arm that is integrally formed with the hollow body as a single structure and in communication with an interior thereof and extends outwardly therefrom and terminates in a distal end that is attached to vacuum source. The boot has a first vent feature integrally formed at and spaced circumferentially about the distal end of the hollow main body to vent the interior of the main body and permit negative pressure to be generated therein due to operation of the vacuum source resulting in the unwanted foreign matter being drawn into the interior and evacuated through the arm to the vacuum source.

Further aspects and features of the exemplary automated safety cap removal mechanism disclosed herein can be appreciated from the appended Figures and accompanying written description.

### BRIEF DESCRIPTION OF THE DRAWINGS

FIG. 1 is a diagrammatic side view of a dust suppression boot or guide operatively connected to a vacuum source and a power tool;

FIG. 2 is a side elevation view of the dust suppression boot;

FIG. 3 is a top plan view of a main body of the dust suppression boot;

FIG. 4 is a bottom plan view of the main body of the dust suppression boot;

FIG. 5 is a cross-sectional view of the dust suppression boot without the two fastening members being shown;

FIG. 6 is a cross-sectional view taken along the line 6-6 of FIG. 2;

FIG. 7 is a side view of the dust suppression boot illustrating a hollow arm of the dust suppression boot;

FIG. 8 is a diagrammatic side view of the dust suppression boot operatively connected to a vacuum source and a power tool and illustrating air flow channels defined in the boot.

### DETAILED DESCRIPTION OF PREFERRED EMBODIMENTS

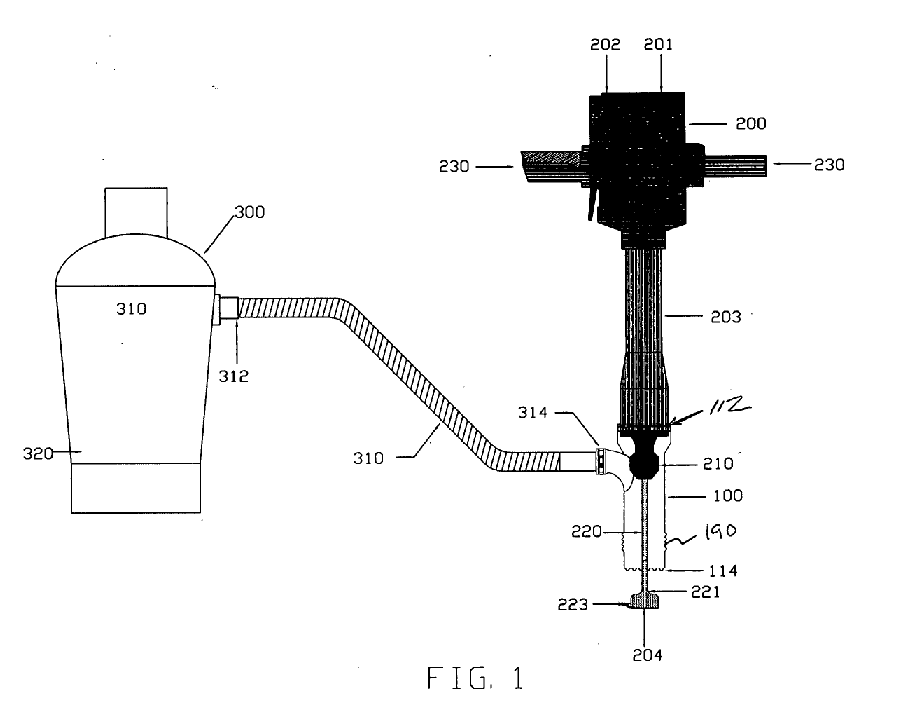

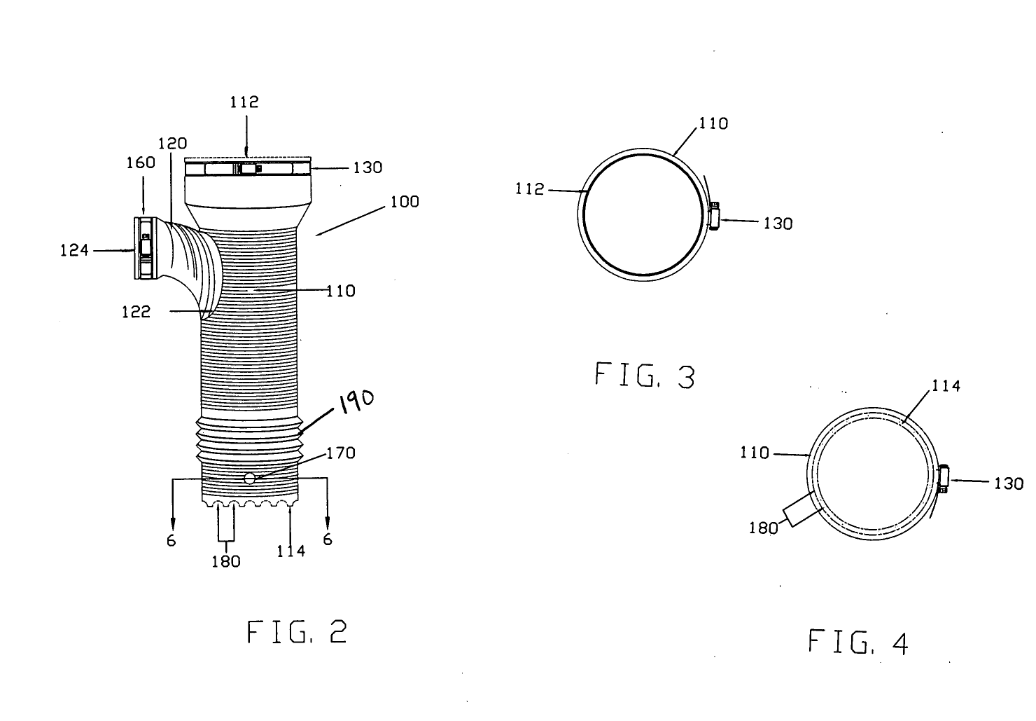

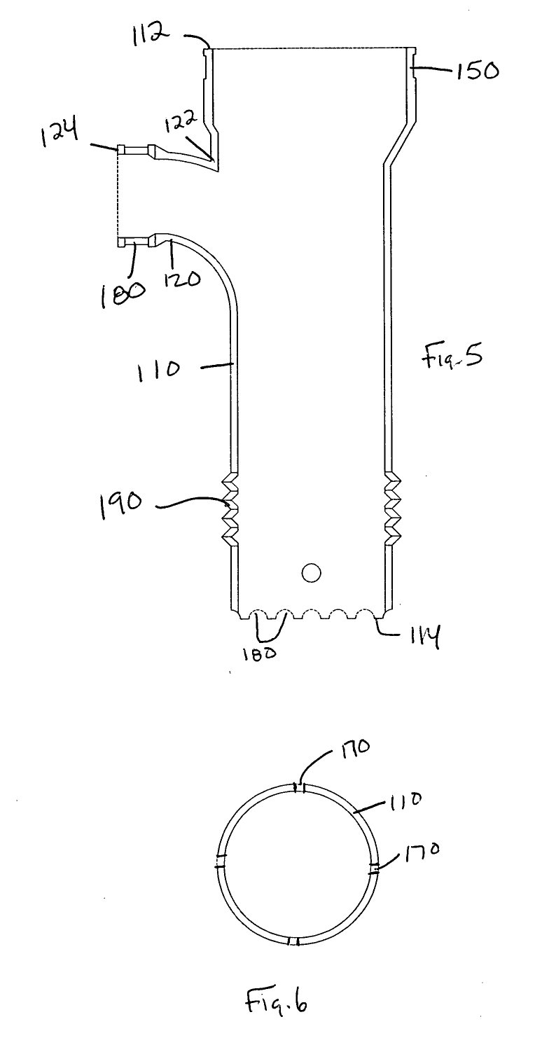

FIGS. 1-8 illustrate a dust suppression boot 100 for use with a power tool according to one embodiment of the present invention. As shown schematically in FIG. 1, the dust suppression boot 100 is designed to be used with a power tool 200, such as a percussive tool, e.g., jackhammer; however, the guard 100 can be used with other tools, such as air-hammers, concrete breakers and coring machines. The dust suppression boot 100 is constructed so that when it is used with the power tool 200, it limits the spread of dust that is generated and agitated while the tool 200 is used to cut or otherwise impact a concrete surface or a similar hard surface that generates dust and particles when the surface is impacted by the power tool 200. One will appreciate that while a primary function of the dust suppression boot 100 is to collect and limit the travel of dust, particles and other foreign matter, the boot 100 also provides a safety function in that it prevents the same debris from being discharged towards and potentially injuring the operator of the power tool 200 since, as described below, the boot 100 is constructed to collect the debris at a distal location near the concrete surface that is being cut and therefore, the debris can not become a projectile towards the body, especially the head and eyes of the operator.

The dust suppression boot 100 is designed to be operatively connected to a vacuum source 300 which provides the means for evacuating the dust, debris and other foreign matter into the distal end of the boot 100 where it is collected and is then routed to a collection location 310, which is most often associated with the vacuum source 300. Additional details concerning the connections and operation of the vacuum source 300 are described below.

As previously mentioned, the power tool 200 is typically a percussive power tool, such as a jackhammer (e.g., a spline drive jackhammer); however, the tool 200 can equally be another type of tool, such as an air-hammer, etc. In view of the foregoing, the boot 100 of the present invention is discussed and illustrated in terms of its use with a jackhammer 200; however, it will be appreciated that this is merely one illustrative use and is not limiting of the scope of the present invention.

A typical percussive tool 200 in the form of a jackhammer is illustrated in FIG. 1. As is known, a jackhammer is a portable percussive drill, many times operated by compressed air and used to drill the concrete surface or the like. It works in the manner of a hammer and chisel, by jabbing with its bit, not by rotating it (as is the case with an air-drill (windy-drill)). During operation, the jackhammer relies on the inertia of the mass of its body to impel the bit into the work (e.g., concrete surface) and therefore, the mass should be supported by the work and therefore, the work should be a level ground surface, etc. In addition, gravity is required to bring the mass back into contact with the work after each blow.

The jackhammer 200 has a proximal end 202 and an opposing distal end 204 which is where a cutting bit or cutting component 220 of the tool 200 is located. The jack hammer 200 includes an elongated body that includes a first housing 201 that contains a motor and other electronic components and a second elongated housing 203 that extends from the first housing 201 and includes other working components and is coupled to a tool holder 210 such that the tool holder 210 is driven by the motor in a reciprocating manner, as well as typically having some degree of rotation. The tool holder 210 is configured to receive and interlock with a cutting tool (bit) 220. The cutting tool 220 is an elongated structure that terminates in a cutting bit 221. The cutting tool 220 can have any number of different shapes including, in the illustrated embodiment, a circular cross-section. The cutting bit 221 is typically an outwardly tapered structure that has a width that is greater than the width (diameter) of the elongate shaft of the cutting tool 220. The cutting bit 221 has two opposing faces that come to a cutting edge 223.

At or near the proximal end 202 and formed as part of the first housing 201 is a pair of handles 230 to allow the operator to hold the device with two hands since cutting the concrete surface requires the jackhammer 100 to be held securely since a great amount of percussive force is required to break apart the concrete surface. Controls for the device 100 are also located at the proximal end of the device 100 and typically are part of the handles 230.

The cutting tool 220 usually has smaller dimensions than the second housing 203 and it is the cutting tool holder 210 and cutting tool 220 at the distal end of the apparatus 200 that are designed to move in a reciprocating manner so as to cause the cutting bit 221 to strike the concrete surface with such repeated force that the concrete surface is broken apart into smaller concrete blocks, particles and of course, concrete dust is generated as the concrete surface is pulverized. As can be seen in the Figures, the cutting bit 221 is integrally formed at the distal end of the tool 210 and has a chisel like shape formed of two opposing flat faces that come to the edge 223 that is brought into contact with the concrete surface.

The cutting tool 220 most often has a generally circular shape; however, other shapes are possible, such as an oval shape or even more of a square shape or an irregular shape. The second housing 203 acts to receive and surround at least a portion of the tool holder 210, while permitting it to move in a reciprocating manner as the tool 220 repeatedly strikes the concrete surface. It is at this area below the second housing 203 where the holder 210 and cutting tool 220 are located that the dust is created and becomes airborne and can spread all over the work space in the absence of the boot 100 of the present invention.

The boot 100 according to one embodiment of the present invention and as illustrated in the Figures is made of an elongate main body 110 that has a proximal end 112 and an opposing distal end 114. The shape of the body 110 can vary and according to one embodiment, the body 110 has a generally circular cross-sectional shape. However, it will be appreciated that this shape is merely exemplary and does not limit the scope of the present invention since the body 110 can have any number of different cross-sectional shapes so long as the body 110 has a cross-sectional shape that is complementary to the shape of the jack hammer 200 and in particular, the second housing 203 and cutting tool 220 thereof, so as to permit the boot 100 to surround at least a portion of the second housing 203 so as to enclose the tool holder 210 and at least a length of the cutting tool 220. In a non-operating state, when the jack hammer 200 is at rest and the boot 100 is attached thereto, at least a portion of the cutting bit 221 (e.g., cutting edge 223) extends beyond the end 114 of the main body 110.

The body 110 is thus a hollow member and it can be made of any number of different materials and can be manufactured according to any number of different techniques. For example and according to one embodiment, the body 110 is made of a plastic material and in particular a plastic material that is sufficiently rigid to keep its form yet has some flexibility to permit some compression. In particular, the body 110 of one preferred embodiment is formed of an injection moldable material and thus, the boot 100 is formed by an injection molding process. One type of suitable injection moldable material is a soft flexible vinyl material that has some flexibility to allow the boot 100 to perform its intended function as described below. As will be described below, when the bottom edge (distal end 114) of the boot 100 contacts the working surface during operation of the jackhammer 200 as the cutting tool 220 moves in a reciprocating manner, the body 110 is capable of slightly compressing to permit the normal operation of the jackhammer 200; however, the venting features (described below) of the boot 100 are not jeopardized if the boot 100 slightly compresses at the distal end 114.

Other types of materials that are suitable are other synthetic materials, such a neoprene, butyl rubber, siliconized rubber, to name just a few. It will thus be appreciated that a number of different polymeric materials can be used to form the boot 100 and still give it its intended, desired properties. In one embodiment, the boot 100 generally has the same or similar flexibility as a heavy duty plastic garden hose and thus, while it can be compressed, some degree of force is needed to compress it. These material properties also permit the boot 100 to be circumferentially compressed by a fastening element so as to cause the boot 100 to be securely coupled or attached to another member, such as jackhammer 200.

As can be seen from the figures, the diameter of the body 110 is not constant from the proximal end 112 to the distal end 114 since a number of integral features of the body 110, as described below, cause the diameter of the body 110 to not be constant along its entire length.

As can be seen in FIG. 1, the proximal end 112 is designed to be operatively connected to the second housing 203, while the distal end 114 is the end which faces the concrete surface that is to be cut.

The boot 100 has an integral feature 120 that permits it to be operatively and preferably sealingly attached to the vacuum source 300. More specifically, the boot 100 includes an integral snout or arm 120 that extends outwardly from an outer surface of the body 110 at a location that is closer to the proximal end 112 as opposed to the distal end 114. The arm 120 has a proximal end 122 that is integrally attached to the body 110 of the boot 110, while an opposite distal end 124 is spaced outwardly from the body 110 and serves as the end that is operatively attached to the vacuum source 300.

The arm 120 is a hollow member that is in fluid communication with the interior (hollow portion) of the main body 110 to permit the dust and particles that are evacuated into the body 110 to freely travel into the interior of the arm 120 due to a pressure differential as a result of operation of the vacuum source 300. The illustrated arm 120 is not formed at a right angle to the body 110 but rather is slightly angled such that an angle between the top surface of the arm 120 and the adjacent vertical wall of the body 110 is less than 90 degrees (as a result, the angle formed between the bottom surface of the arm 120 and the adjacent vertical wall of the body 110 is greater than 90 degrees).

The length of the arm 120 can vary so long as it is of sufficient length to permit the vacuum source 300 to be operatively coupled to the arm 120. The illustrated arm 120 has a generally circular cross-sectional shape; however and once again, the shape of the arm 120 can vary and is not critical so long as the evacuated dust and particles can freely travel into the body 110 and travel freely into the arm 120.

In the preferred illustrated embodiment, the arm 120 and body 110 are a single, unitary, integral piece due to the boot 100 being formed by means of an injection molding process as described below.

In order to securely attach the boot 100 to the power tool 200 and in particular, the second housing 203 thereof, the proximal end 112 of the main body 110 includes a first fastenening means 130 that not results in the boot 100 being securely attached to the second housing 203 but also is preferably of the type that permits the boot 100 to be freely and easily removed from attachment to the second housing 203 and further, is of the type that permits the boot 100 to be fitted to a vast number of existing jack-hammer constructions. In other words, the boot 100 can be retrofitted on a vast number of existing jackhammers 200 that are commercially available. For example, spline drive jackhammers can come in 40, 60, 80, 85, 90 and even 120 lb styles.

In order to accommodate the first fastening means 130, the proximal end 112 includes a section 150 of reduced dimension that receives the first fastening means 130. Since the body 110 is generally circular in its cross-sectional shape, the section 150 is in the form of a recessed annular ring that is formed in and around the body 110. This ring 150 in effect defines an annular track that receives the first fastening means 130 and serves to retain the first fastening means 130 since it is recessed relative to the surrounding sections and thus, prevents the first fastening means 130 from migrating along the surface of the body 110 since it is retained in the track. The first fastening means 130 is configured to cause a controlled reduction of the diameter of the body 110 near the proximal end 112 of the body 110 in order to sufficiently tighten the proximal end 112 of the body 110 resulting in the boot 100 being securely coupled to the outer surface of the second surface 203 of the power tool 200.

According to one embodiment, the first fastening means 130 is a clamp type device that can be selectively tightened in order to securely attach the boot 100 to the second housing 203 of the jack hammer 200, with the cutting tool 220 disposed in the interior of the boot 100 in such a manner that it can move in a reciprocating manner during normal operation of the power tool 200. The boot 100 should be attached to the second housing 203 at a location where, in a non-operating state or rest position, a portion (e.g., the cutting bit 221) of the cutting tool 220 extends beyond the distal end 114 of the boot 100 so as to be visible.

For example, the first fastening means 130 can be in the form of a hose clamp that can be adjusted by the operator to both tighten and loosen the clamp which thereby tightens the connection to the second housing 203 or releases the boot 100 from the second housing 203, respectively. In one embodiment, the clamp 130 is a stainless steel hose clamp with a hexhead adjusting screw. The clamp 130 is preferably located at or close to the proximal end 112 of the body 110 since it is this end that is disposed about the second housing 203 and thus, it serves as the location to securely attach the boot 100 to the power tool 200. With this type of means 130, the user simply manipulates the adjusting screw to cause either a tightening or a loosening of the clamp 130.

It will be appreciated that other types of fastening means 130 can be used. For example, ratcheting type fastening means 130 can be used to cause the tightening and loosening of the fastening means 130. In addition, a snap-fit type fastening means 130 can be used to cause the selective, releasable fastening of the boot 100 to the second housing 203.

The construction of the body 110 under the first fastening means 130 is sufficiently flexible and resilient such that when the first fastening means 130 is tightened, the underlying body 110, and in particular, the section 150 of reduced diameter, is compressed in this area resulting in the boot 100 being securely attached to the second housing 203.

In order to securely attach the arm 120 to the vacuum source 300 and in particular, to a vacuum conduit 310 thereof, the distal end 124 of the arm 120 includes a second fastenening means 160 for securely coupling the arm 120 to the vacuum conduit 310 but also is preferably of the type that permits the arm 120 to be freely and easily removed from attachment to the vacuum conduit 310 and further, is of the type that permits the arm 120 to be fitted to a vast number of existing vacuum conduit constructions. In other words, the boot 100 can be fitted to a vast number of existing vacuum sources 300 that are commercially available.

According to one embodiment, the vacuum source 300 includes a vacuum canister 320 that acts as a typical vacuum and when operated generates a negative pressure that is communicated to the interior of the main body 110 by means of the vacuum conduit 310 which is in fluid communication, preferably in a sealed manner, with the interior of the body 110. The vacuum conduit 310 has a first end 312 and an opposing second end 314, with the first end 312 being attached to the vacuum canister 320 and the second end 314 being attached to the body 110. The vacuum conduit 310 is preferably a flexible conduit, such as a hose or the like, that has a degree of bendability to permit the canister 320 to be located at one location and the jackhammer 200 at another location, as well as permitting free movement, to a degree, of the jackhammer 200 as the work is performed. It will further be understood that the canister 320 is preferably a mobile unit that can be freely moved, as by rolling the canister 320 on the ground surface; however, the canister 320 can be more permanently mounted. The conduit 310 can also have a bellows type construction to permit the length of the conduit 310 to be freely varied.

In addition, it will be understood that while a dry vac type system is typically used as the vacuum source 300 and in particular, a HEPA filtered vacuum unit, it is possible that the vacuum source 300 be a wet vac type system. This type of system is used when water is present in the work space.

It will also be appreciated that a male/female type fitting can be used for the connection between the conduit 310 and the arm 120. For example, the end of the conduit 310 can have either a male or female fitting and the end of the arm 120 can have the opposite type fitting (i.e., female or male) to permit the end of the conduit 310 to be interlockingly engaged with the arm 120. A releasable snap fit type interlocking system can be used to interlockingly attach the conduit 310 to the arm 120.

In order to accommodate the second fastening means 160, the distal end 124 includes a section 180 of reduced dimension that receives the second fastening means 160. Since the arm 120 is generally circular in its cross-sectional shape, the section 180 is in the form of a recessed annular ring that is formed in and around the arm 120. This ring 180 in effect defines an annular track that receives the second fastening means 160 and serves to retain the second fastening means 160 since it is recessed relative to the surrounding sections and thus, prevents the second fastening means 160 from migrating along the surface of the body 110 since it is retained in the track. The second fastening means 160 is configured to cause a controlled reduction of the diameter of the arm 120 near the distal end 124 of the arm 120 in order to sufficiently tighten the distal end 124 of the arm 120 resulting in the boot 100 being securely coupled to the conduit 310 of the vacuum source 300.

According to one embodiment, the second fastening means 160 is a clamp type device that can be selectively tightened in order to securely attach the boot 100 to the conduit 310 of the vacuum source 300. For example, the second fastening means 160 can be in the form of a hose clamp that can be adjusted by the operator to both tighten and loosen the clamp which thereby tightens the connection to the conduit 310 or releases the boot 100 from the vacuum source 300 (conduit 310), respectively. In one embodiment, the clamp 160 is a stainless steel hose clamp with a hexhead adjusting screw. The clamp 160 is preferably located at or close to the distal end 124 of the arm 120 since it is this end that engages the vacuum conduit 310 and thus, it serves as the location to securely attach the boot 100 to the vacuum source 300. With this type of means 160, the user simply manipulates the adjusting screw to cause either a tightening or a loosening of the clamp 160.

As with the first fastening means 130, the second fastening means 160 can be in a form other than a clamp. For example, the second fastening means 160 can be in the form of a snap-fit fastener or some other type of interlocking members that permit the vacuum conduit 310 to be attached to the arm 120.

In one exemplary embodiment, the diameter of the arm 120 is less than the diameter of the body 110 and therefore, the second fastening means 160 has dimensions that are less than the dimensions of the first fastening means 130. For example and when the first and second fastening means 130, 160 are in the form of clamps, the first fastening means 130 is in the form of a 4½ inch diameter stainless steel clamp when the body 110 has an interior diameter of about 4¼ inches, while the second fastening means 160 is in the form of a 2½ inch diameter stainless steel clamp when the arm 120 has an inner diameter of about 2 inches.

It will be understood that the relative dimensions of the boot 100 can vary in part based on the relative size of the jackhammer 200. For example, one exemplary boot 100 has a length greater than one foot (e.g., 1′1″) and the distance from the top surface of the arm 120 to the top edge (proximal end 112) of the boot 100 being about 2.6 inches, while a distance from the distal end 114 to a point where the body 110 generally deviates from a linear construction to form the arm 120 is about 5.84 inches; however, all of the above dimensions are merely exemplary and do not limit the scope of the present invention. It will be appreciated that the above dimensions are relative to an 85 lb jackhammer; however, the boot 100 is simply scaled to size when jackhammers of other sizes are used.

Since the boot 100 is attached to the second housing 203 that moves in a reciprocating manner, the boot 100 likewise travels in a reciprocating manner with second housing 203 and therefore, the attachment between the boot 100 and the second housing 203 must be robust so that this interface and joint remains solid.

The boot 100 also includes a bellows type structure, generally indicated at 190, to permit the boot 100 to adapt to different work surfaces. More specifically, the body 110 includes a bellows section 190 that permit the length of the body 110 to be both slightly extended and retracted along its longitudinal length, as well as permitting the boot body 110 some degree of lateral flexing or bending. As will be appreciated, the work surface may not be a nice planar surface but instead can have raised sections, such as broken concrete sections and the like, and therefore, as the distal end 114 of the body 110 is brought down to the work surface, one section of the body 110 may contact a raised surface, while the surrounding work surface is at a lower point and thus, the bellows structure 190 permits the one section that is on the raised surface to be intimately engaged with the distal end 114, while the other sections of the distal end 114 of the body 110 are driven into intimate contact with the lower surrounding sections of the work surface. In other words, the bellow structure 190 permits the distal end 114 of the body 110 to engage the work surface in an uneven manner. However, in each event, the distal end 114 intimately seats against the work surface and there are no gaps between the distal end 114 and the work surface since the bellows 190 permit the body 110 to flex and conform to the ground surface contour and topography.

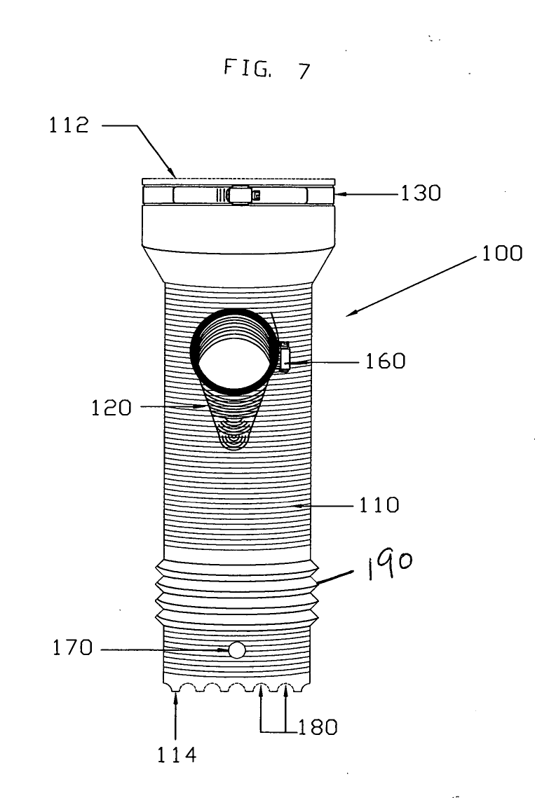

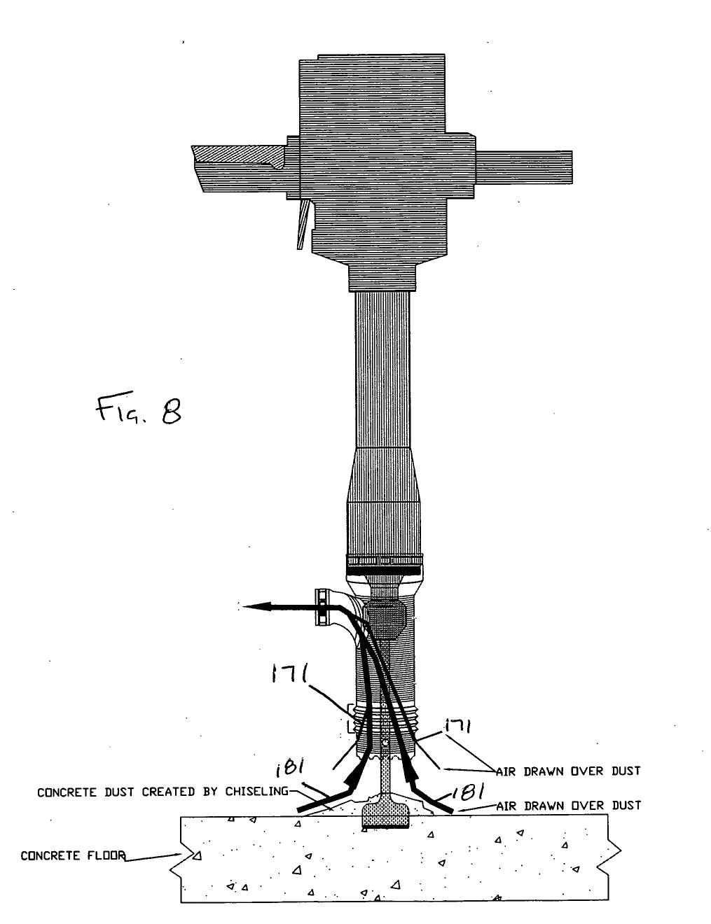

In yet another aspect of the present invention and as best shown in FIGS. 7-8, the boot 100 includes a number of venting features that permit the boot 100 to be used in a vacuum type environment and also facilitate dust being drawn into the main body 110 and then into the arm 120. More specifically, the boot 100 includes a first vent feature 170 and a second vent feature 180. It will be appreciated that in order to create negative pressure within the interiors of the arm 120 and the main body 110, air must flow into these interiors and furthermore, the vent features 170, 180 prevent the arm 120 and the main body 110 from collapsing under the action of the vacuum source 300.

In one embodiment, the first vent feature 170 is in the form of one or more apertures 170 that are formed in the main body 110 at a location that is proximate but spaced from the distal end 114. In the illustrated embodiment, the apertures 170 are formed in the same plane and are spaced circumferentially around the main body 110. For example, there can be four apertures 170 that are spaced about 90 degrees apart from one another. Alternatively, two apertures 170 can be formed 180 degrees apart or three apertures 170 can be formed 120 degrees apart from one another or five apertures 170 can be formed about 72 degrees apart from one another. The one or more apertures 170 serve as an air inlet port that allows air to be drawn into the interior of the main body 110 to allow proper operation of the vacuum source 300 and to maintain the structural integrity of the boot 100. Air flow patterns through the apertures 170 are generally indicated by 171.

The second vent feature 180 is constructed and positioned not only to allow air into the interior, like the apertures 170, to allow proper operation of the vacuum source 300 and ensure structural integrity, but also serves as a “sweep” feature that creates air flow currents or pathways that draw the generated dust, particles, foreign matter, and the like, into the interior of the main body 110 at the distal end 114 of the boot 100. The second vent feature 180 is in the form of a scalloped shaped second end 114 of the boot 100 that has a series of notches or partially openings 180 formed at the distal end 114. More specifically, the notches 180 have semi-circular shapes and are formed in a series, repeating pattern around the entire circumference of the second end 114.

The notches 180 are formed at the distal end 114 which is the portion of the boot 100 that is closest to or in selective contact with the work surface (concrete surface) as the jackhammer 200 is operated and the cutting bit 221 impacts the work surface. When the second end 114 of the boot 100 is in contact with the work surface, the notches 180 permit air to flow along the work surface and be drawn into the interior of the main body 110 so as to maintain integrity of the structure and allow negative pressure in the interior. In addition, this air flow along the work surface captures and draws the generated dust, particles and foreign matter into the interior of the main body 110. In other words, the notches 180 facilitate the collection of the unwanted dust, particles, etc., and the routing of this material to the canister of the vacuum source 300. Air flow patterns where air drawn over the dust and foreign matter on the work surface and through the notches 180 are generally indicated at 181.

Preferably, the apertures 170 are located below the arm 120 (between the end 114 and the entrance into the arm 120) so as to allow air flow into the interiors of both the main body 110 and the arm 120; however, the apertures 170 can be located at other locations with respect to the main body 110, e.g., above the arm 120.

Preferably, the bellows structure 190 is formed above the apertures 170 as shown in order to optimize the air flow into the body 110 by placing the apertures 170 closer to the distal end 114. However, it is possible to form the bellows structure 190 in between the apertures 170 and the notches 180.

According to one embodiment, the body 110 of the boot 100 is formed as a single, integral unitary structure that is formed of the same material and is formed by means of an injection molding process or another molding process. This uniform construction in which the boot 100 (arm 120 and body 110) is formed of the same material is an improvement of the conventional designs that are much more complicated and further, the manufacturing process for making the boot 100 is much simpler than the previous manufacturing processes. In other words, an injection molding process can be used to form the boot 100 and since the boot 100 is a single structure, there is no assembly of parts or other steps that consume time and thus, increase the cost of the process and the product itself.

One of the advantages of the boot 100 according to the present invention is that the boot 100 is capable of being retrofitted to a number of different styles, sizes and types of jackhammers 200. Since the cutting bit 220 is typically wider than the second housing 203, the inner diameter of the body 110 is such that the body 110 can be fit over the cutting bit 220 and moved up along the second housing 203 until the upper edge (end 112) of the body 110 is positioned at a location of the second housing 203 where it is to be joined.

Not only does the boot 100 collect dust but it also collects, solid foreign matter, such as concrete pieces, as well as other undesirables, such as carcinogens and mold, etc.

It will be appreciated by persons skilled in the art that the present invention is not limited to the embodiments described thus far with reference to the accompanying drawings; rather the present invention is limited only by the following claims

What is claimed is:

1. A dust suppression boot for attachment to a power tool comprising:
a hollow main body having a first end for attachment to a body of the power tool and an opposing second end for positioning proximate a cutting component of the power tool;
a hollow arm that is integrally formed with the hollow body as a single structure and in communication with an interior thereof and extends outwardly therefrom and terminates in a distal end; and
a first vent feature formed at and spaced circumferentially about the distal end of the hollow main body to define airflow channels.

2. The dust suppression boot of claim 1, wherein the main body and hollow arm comprise an injection molded article.

3. The dust suppression boot of claim 1, further including:
a first adjustable fastening means that is disposed at the first end of the main body for securely attaching the main body to the power tool; and
a second adjustable fastening means that is disposed at the distal end of the arm for securely attaching the arm to a vacuum source.

4. The dust suppression boot of claim 3, wherein the main body includes an annular recessed track formed circumferentially about the first end thereof for receiving the first fastening means and the distal end of the hollow arm includes an annular recessed track formed circumferentially about the distal end of the hollow arm for receiving the second fastening means.

5. The dust suppression boot of claim 1, wherein the first end of the main body includes an annular section having a reduced thickness to receive a first fastening member and permit compression of the main body so as to allow the boot to be securely attached to the power tool and wherein the distal end of the arm includes an annular section having a reduced thickness to receive a second fastening member and permit compression of the arm so as to allow the arm to be securely attached to a vacuum source.

6. The dust suppression boot of claim 5, wherein the first and second fastening members comprise adjustable clamps.

7. The dust suppression boot of claim 5, wherein the first and second fastening members comprise snap-fit fittings that mate with complementary fittings associated with the power tool and vacuum source, respectively.

8. The dust suppression boot of claim 1, wherein a diameter of the main body is greater than a diameter of the arm.

9. The dust suppression boot of claim 1, wherein the first vent feature is in the form of a series of notches that are spaced and formed circumferentially about the second end of the main body, the notches being open at the second end and define a series of apertures that are open when the second end is placed on a work surface.

10. The dust suppression boot of claim 9, wherein each notch comprises a semi-circular shaped opening.

11. The dust suppression boot of claim 1, further including:
a second vent feature that is formed proximate the second end of the main body and spaced from the first vent feature and defines a fluid opening into the interior of the main body.

12. The dust suppression boot of claim 11, wherein the second vent feature comprises one or more apertures formed in the main body and spaced from the first vent feature.

13. The dust suppression boot of claim 11, wherein two or more apertures are formed circumferentially about the main body.

14. The dust suppression boot of claim 13, wherein there are four apertures formed 90 degrees apart from one another and contained within the same plane.

15. The dust suppression boot of claim 1, wherein the boot is formed of a semi-flexible material that permits some compression thereof when a force is applied to the boot, with at least a first section where the boot is attached to the power tool and a second section where the boot attached to a vacuum source being compressible.

16. The dust suppression boot of claim 1, wherein the arm is formed at least in an upper half of the main body.

17. The dust suppression boot of claim 1, further including:
a bellows structure formed along a length of the body to permit the body length to be altered and to permit lateral flexing of the body.

18. A power tool assembly comprising:
a percussive power tool having a cutting tool with a cutting edge;
a vacuum source; and
a dust suppression boot for attachment to the power tool and the vacuum source and being constructed to evacuate unwanted foreign matter from a work space, including:
a hollow main body having a first end for attachment to a body of the power tool and an opposing second end, wherein in a rest position, the cutting edge extends beyond the second end;
a hollow arm that is integrally formed with the hollow body as a single structure and in communication with an interior thereof and extends outwardly therefrom and terminates in a distal end; and
a first vent feature integrally formed at and spaced circumferentially about the distal end of the hollow main body for venting the interior of the main body and permitting negative pressure to be generated therein due to operation of the vacuum source, thereby resulting in the unwanted foreign matter being drawn into the interior of the main body and evacuated through the arm to the vacuum source.

19. The assembly of claim 18, wherein the percussive power tool comprises a jackhammer.

20. The assembly of claim 18, wherein the vacuum source includes a portable vacuum canister to collect unwanted foreign matter and a flexible conduit that is operatively connected at one end to the vacuum canister and at another end to the distal end of the arm of the boot.

21. The assembly of claim 18, wherein the main body and hollow arm comprise an injection molded article formed in situ in a common mold.

22. The assembly of claim 18, wherein the main body includes an annular recessed track formed circumferentially about the first end thereof for receiving a first fastening means for adjustably compressing the first end until a secure connection is made to a housing of the power tool and the distal end of the hollow arm includes an annular recessed track formed circumferentially about the hollow arm for receiving a second fastening means for adjustably compressing the distal end until a secure connection is made to a vacuum conduit associated with the vacuum source.

23. The assembly of claim 22, wherein the first and second fastening members comprise one of adjustable clamps and snap-fit fittings.

24. The assembly of claim 18, wherein the first vent feature is in the form of a series of notches that are spaced and formed circumferentially about the second end of the main body, the notches being open at the second end and define a series of apertures that are open when the second end is placed on a work surface.

25. The assembly of claim 18, further including:
a second vent feature that is formed proximate the second end of the main body and spaced from the first vent feature and defines a fluid opening into the interior of the main body.

26. The assembly of claim 25, wherein the second vent feature comprises one or more apertures formed in the main body and spaced from the first vent feature.

27. The assembly of claim 26, wherein two or more apertures are formed circumferentially about the main body.

28. A dust suppression boot for attachment to a percussive power tool containing and evacuating foreign matter from a work space comprising:
a hollow main body having a first end for attachment to a body of the power tool and an opposing second end for positioning proximate a cutting component of the power tool;
a hollow arm that is integrally formed with the hollow body and in communication with an interior thereof and extends outwardly therefrom and terminates in a distal end, wherein the main body and the hollow arm comprise an injection molded article that is formed of the same injection moldable material; and
a first vent feature formed at the distal end in the form of a plurality of circumferentially spaced airflow ports that in an operating state when the second end of the main body is proximate or in contact with the work surface create a sweeping effect in which the foreign matter entrained in air is drawn into the interior of the main body.
